(19) United States
(12) Patent Application Publication
(10) Pub. No.: US 2008/0033766 A1
(43) Pub. Date: Feb. 7, 2008

(54) SYSTEM AND METHOD FOR A SEPARATE ACCOUNT MORTGAGE

(76) Inventor: Michael E. Troxler, Battle Ground, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/835,345

(22) Filed: Aug. 7, 2007

Related U.S. Application Data
(60) Provisional application No. 60/836,351, filed on Aug. 7, 2006.

(51) Int. Cl. G06Q 40/00

(52) U.S. Cl. 705/4; 705/35

(57) ABSTRACT

Aspects of the present invention are directed at integrating a home mortgage with a vehicle for long-term savings and investment. In this regard, a method is provided that increases the capital available to a borrower when compared to traditional mortgages, such as a 30-year fixed mortgage. The method includes establishing an integrated account of a mortgage and an investment vehicle that receives periodic payments from the borrower. Payments received from the borrower are bifurcated so that a portion of the payment is directed to the mortgage and the remaining portion is directed to the investment vehicle. In this regard, the method provides means for growing capital directed to the investment vehicle at a rate that is greater than the cost of the interest on the mortgage.

### BACKGROUND

Financial transactions can entail establishing a series of payments over time to either purchase an item or settle or resolve a debt. A common example of a financial transaction that typically requires repayment over time includes a home mortgage contract in which repayment of the loan is secured by the real property. Various types of repayment plans are available in the marketplace for home mortgages. However, the primary instrument for purchasing real estate has traditionally been the 30-year fixed mortgage with a fully amortized payment (hereinafter referred to as a “30-year fixed” loan or mortgage). This mortgage utilizes a fixed interest rate that remains constant during the life of the loan. The primary financial goal for this type of mortgage is simply to complete repayment over a 30-year term. However, the amortized schedule that currently exists with most 30-year fixed mortgages is designed so that interest is primarily paid for the first twenty-three (23) years of repayment. Only during the last seven (7) years of the loan will the principal amount be reduced significantly.

For taxpayers itemizing deductions, interest expenses incurred are generally deductible as described in Internal Revenue Service (IRS) Publication 936, “Home Mortgage Interest Deduction.” In this regard, home mortgage interest is any interest paid on a loan that is secured by a home, within certain limits. The loan may be a mortgage to buy a home, a second mortgage, a line of credit, a home equity loan, and the like. The deductibility of interest incurred on a home loan as well as consumers' desire to minimize out-of-pocket expenses has led to a number of new loan products. For example, interest-only loans, hybrid and piggyback loans, negative amortization loans, and the like have all have been introduced as real estate affordability has declined.

More recently developed loan products are typically designed to lower the monthly payment when compared to a 30-year fixed loan. As a result, the amount of interest paid over the life of the loan also increases, thereby maximizing the tax deduction realized by a borrower. However, a drawback to some of these loan products is that the rate of interest may be variable. Moreover, the amount of principal being paid down is typically less when compared to a 30-year fixed loan. As a result, the borrower may not build sufficient equity to maintain ownership during retirement or withstand an increase in interest rates. In contrast, the interest rate of a 30-year fixed loan remains constant and the amortization schedule insures that the principal is paid. As a result, the 30-year fixed mortgage continues to be used to protect home owners against variable interest rates, even though the tax savings achieved is less than other products.

In regard to investment by individuals and homeowners, the majority of investments are made by people in the upper ten percent income bracket since they have sufficient personal capital to risk. In comparison, lower and middle income people do not easily accumulate capital to invest since their entire income is required for the expenses of daily living. In this regard, there is a need for a system that integrates savings and/or life insurance into a loan product. There is also a need for a system that maximizes the tax savings for home ownership while minimizing risks caused by market fluctuations. Preferably, such a system would allow a borrower to maximize the interest deduction and have a portion of the payment set-a-side in a no-risk or low-risk and tax favored investment.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Aspects of the present invention are directed at integrating a home mortgage with a vehicle for long-term savings and investment. In this regard, a method is provided that increases the capital available to a borrower when compared to traditional mortgages, such as a 30-year fixed mortgage. The method includes establishing an integrated account of a mortgage and an investment vehicle that receives periodic payments from the borrower. Payments received from the borrower are bifurcated so that a portion of the payment is directed to the mortgage and the remaining portion is directed to the investment vehicle. In this regard, the method provides means for growing capital directed to the investment vehicle at a rate that is greater than the cost of the interest on the mortgage.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 depicts a payment allocation system that may be used to implement aspects of the present invention;

FIG. 2 depicts components of a computer that may be used to implement additional aspects of the present invention;

FIGS. 3A-3B depict financial statements that illustrate benefits of using the present invention; and

FIG. 4 depicts an amortization schedule that illustrates benefits of using the present invention.

### DETAILED DESCRIPTION

Generally described, aspects of the present invention integrate a home mortgage with a vehicle for long-term savings and investment. In this regard, a mortgage product is utilized to free capital that would otherwise be used to pay down the principal of the mortgage. This capital is directed into an investment vehicle that can accept large contributions and provide tax favored growth at a rate that is greater than the cost of the interest on the mortgage. The illustrative examples described herein are not intended to be exhaustive or to limit the invention to the precise forms disclosed. Similarly, any steps described herein may be interchangeable with other steps, or combinations of steps, in order to achieve the same result.

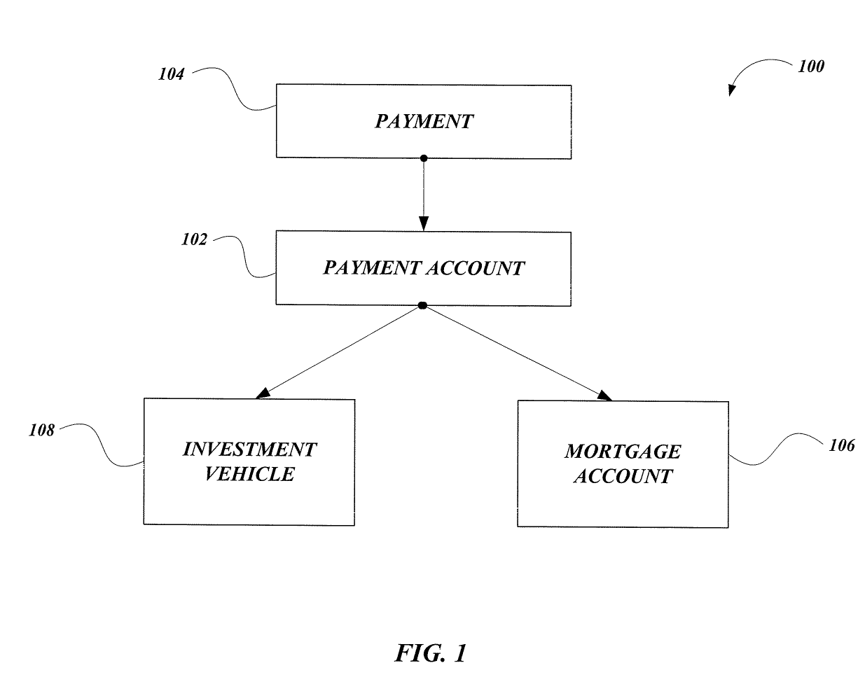

With reference now to FIG. 1, a payment allocation system 100 implemented by aspects of the present invention will be described. In accordance with one embodiment, the system 100 includes a payment account 102 into which a borrower deposits a regular payment 104. These funds may be deposited from any source, such as a check, and may be deposited automatically. When the payment 104 is received and the payment account 102 is credited, aspects of the present invention bifurcate the payment 104 into separate yet fully integrated accounts; namely, the mortgage account 106 and the investment vehicle 108. In the embodiment illustrated in FIG. 1, the mortgage account 106 is associated with a mortgage product that is designed to free capital when compared to a 30-year fixed mortgage. Moreover, the investment vehicle 108 is a mechanism that accepts capital contributions and grows these contributions at a rate that is greater than the cost of the interest on the mortgage.

In accordance with one embodiment of the present invention, the mortgage account 106 is used for the payment of a fixed rate interest-only mortgage. Those skilled in the art and others will recognize that a fixed rate interest-only mortgage is a mortgage in which the borrower makes a regular payment that covers the interest on the loan. Interest-only payments are available on a variety of loan products including but not limited to adjustable-rate mortgages and fixed-rate mortgages. On a fixed-rate mortgage, the rate is fixed for the term of the loan. On a fixed rate mortgage with an interest only payment, the interest-only payment is allowed for a predetermined period of time, such as the first 10 or 15 years of the mortgage. An interest only payment is less when compared to a 30-year fixed mortgage. In this regard, an interest only payment is based on simple interest as compared to a fully amortized payment that uses amortized interest. Amortized interest results in higher upfront interest payments earlier in the loan terms and is sometimes referred to as “front-loaded” interest. In addition, the interest-only payment is lower because the principal is not being paid down. Conversely, the amount of interest being paid by the borrower is larger when compared to a 30-year fixed mortgage. In one embodiment, the fixed rate interest-only mortgage is selected as the loan type in order to free capital for savings/investment. As a result, the tax deduction for the borrower under the Federal Income Tax and Federal Alternative Minimum Tax is larger than would be using a 30-year fixed mortgage. In one embodiment, this extra tax savings achieved by using the fixed rate interest-only mortgage is also invested to increase savings/investment.

In one embodiment, the investment vehicle 108 is implemented as an Equity-Indexed Universal Life Insurance Policy (“EIUL”). Those skilled in the art and others will recognize that capital contributed to the EIUL grows at either a fixed rate or at a rate associated with a particular index such as the S&P 500. Typically, an EIUL has a guaranteed floor that prevents the borrower from incurring losses in a downturn of the market and gains may be “locked-in” during a particular strategy period. Moreover, all capital contributed to the EIUL grows tax-deferred and may be excluded from taxable income if accessed properly. See IRC§7702 and IRC§72(e). In order to grow tax-deferred and be excluded from taxable income, the EIUL includes a death benefit that may be payable to a surviving spouse or other beneficiary. Moreover, the borrower may access funds in the EIUL in the event of emergency or any other need. In the meantime, until there is a need for the borrower to access funds, the capital in the EIUL is working to generate an additional cash flow stream.

In the embodiment depicted in FIG. 1, the payment 104 is bifurcated into the mortgage account 106 and the investment vehicle 108. As a result, a borrower utilizes a mortgage that provides a greater tax deduction than a traditional fixed-rate mortgage. At the same time, the borrower is also allocating capital to a savings/investment vehicle that grows tax-deferred and may be excluded from taxable income if accessed properly. In one embodiment, this is accomplished with the same payment amount that would be required with a traditional 30-year fixed mortgage.

It should be well understood that the exemplary mortgages and investment vehicles described above with reference to FIG. 1 should be construed as exemplary and not limiting. In this regard, the example depicted in FIG. 1 utilizes a fixed rate interest-only mortgage to free capital that is diverted to a savings/investment vehicle. However, other currently existing or yet to be developed mortgage products may be used other than a fixed rate interest-only mortgage. Similarly, the description provided with FIG. 1 utilizes an EIUL as the investment vehicle where capital is diverted for savings/investment purposes. However, those skilled in the art and others will recognize that other, currently existing or yet to be developed investment vehicles may be utilized by aspects of the present invention. Thus, the specific examples provided above with reference to FIG. 1 should be construed as exemplary.

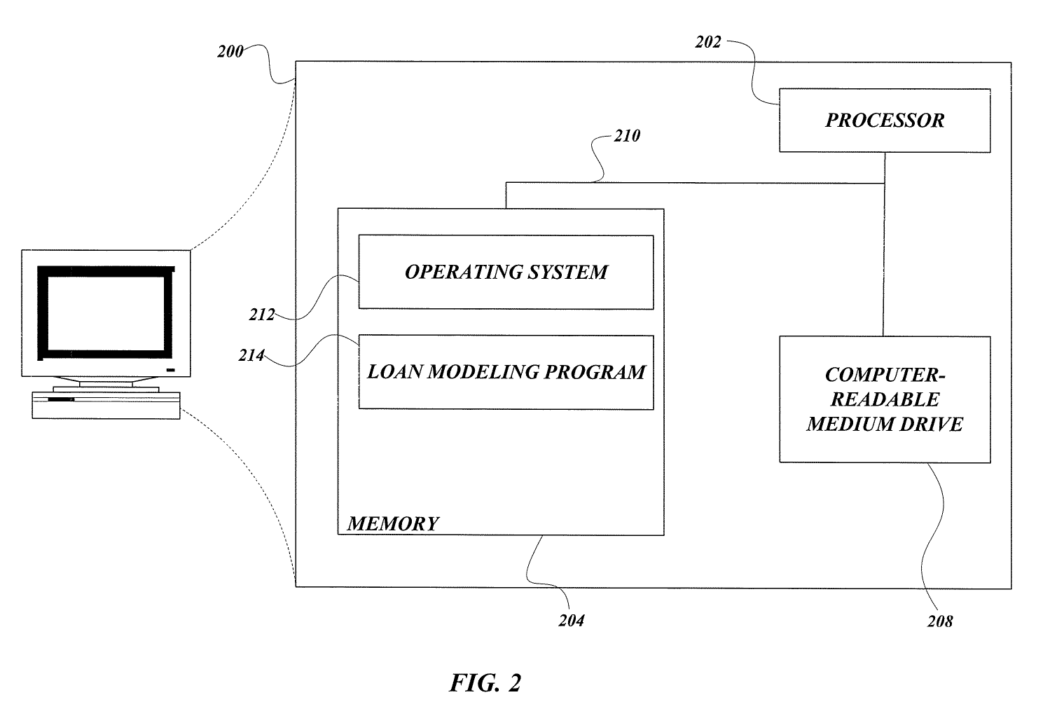

Now with reference to FIG. 2, an exemplary computer 200 with components that are capable of implementing aspects of the present invention will be described. Those skilled in the art and others will recognize that the computer 200 may be any one of a variety of devices including, but not limited to, personal computing devices, server-based computing devices, mini and mainframe computers, laptops, or other electronic devices having some type of memory. For ease of illustration and because it is not important for an understanding of the present invention, FIG. 2 does not show the typical components of many computers, such as a keyboard, a mouse, a printer, a display, etc. However, the computer 200 depicted in FIG. 2 includes a processor 202, a memory 204, a computer-readable medium drive 208 (e.g., disk drive, a hard drive, CD-ROM/DVD-ROM, etc.), that are all communicatively connected to each other by a communication bus 210. The memory 204 generally comprises Random Access Memory (“RAM”), Read-Only Memory (“ROM”), flash memory, and the like.

As illustrated in FIG. 2, the memory 204 stores an operating system 212 for controlling the general operation of the computer 200. The operating system 212 may be a general purpose operating system, such as a Microsoft® operating system, a Linux® operating system, or a UNIX® operating system. Alternatively, the operating system 212 may be a special purpose operating system designed for non-generic hardware. In any event, those skilled in the art and others will recognize that the operating system 212 controls the operation of the computer by, among other things, managing access to the hardware resources and input devices. For example, the operating system 212 performs functions that allow a program to read data from the computer-readable media drive 208.

As further depicted in FIG. 2, the memory 204 additionally stores program code and data that provides a loan modeling program 214. In one embodiment, the loan modeling program 214 comprises computer-executable instructions that, when executed by the processor 202, implements functionality to determine whether a separate account mortgage system as described above with reference to FIG. 1 serves a borrower's financial interest. In this regard, the loan modeling program 214 provides functionality for comparing different loan/investment programs and identifying the program that will generate the most capital for the borrower.

Those skilled in the art and others will recognize that a large number of variables affect which loan/investment product should be used given the particular circumstances of the borrower. For example, the future marginal tax rate for the borrower affects the extent in which interest on a home mortgage is deductible. Accordingly, the loan modeling program 214 models the separate account mortgage provided by aspects of the present invention using the borrower's own financial information to compute net interest expenses for the mortgage, balance of the investment vehicle over time, and the like. Moreover, this information may also be computed for other types of loans and/or investment products. By comparing the results produced by the loan modeling program 214, a loan/investment product that generates the most capital for a borrower may be readily identified.

In one embodiment, the loan modeling program 214 allows a user to input various model parameters so that the best loan/investment product may be identified. These model parameters include, but are not limited to the fair market value of the property, interest rates for each mortgage, down payment, loan amounts, and the like. Once the parameters are input, the loan modeling program 214 performs calculations to compute net interest expenses for the different mortgages, predicted balance of the investment vehicle, etc. In one embodiment, these calculations are based on a number of assumed variables that are provided to assist in the planning process. More specifically, variables provided by the loan modeling program 214 include, but are not limited to standard time value of capital, loan-to-value ratio, marginal tax rate, and rate of return on investment. Of course, these variables may be configured by the user depending on individual situations and changes in market conditions. Once the calculations have been performed, output is produced that provides a side-by-side comparison of the amount of capital available to the borrower when particular mortgage products are used.

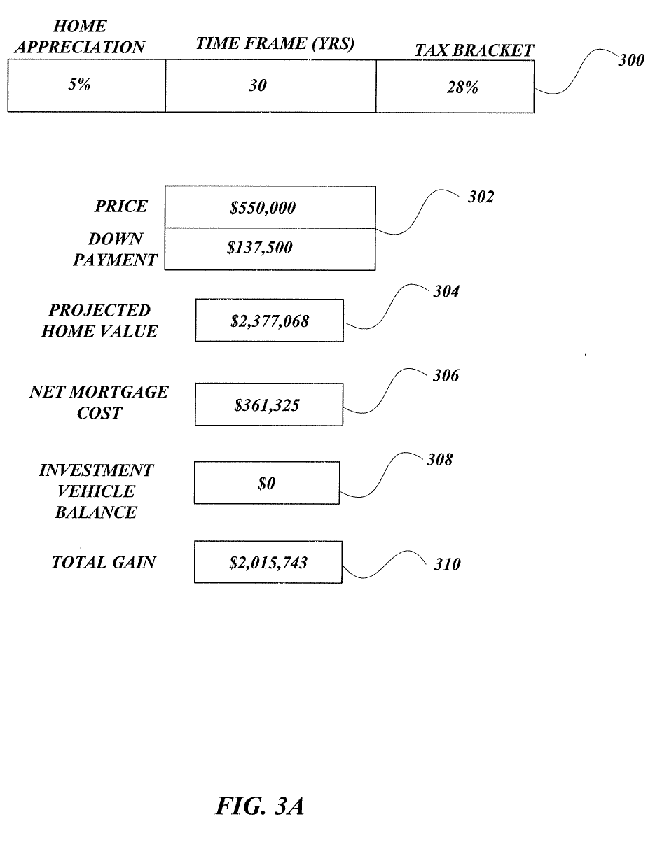

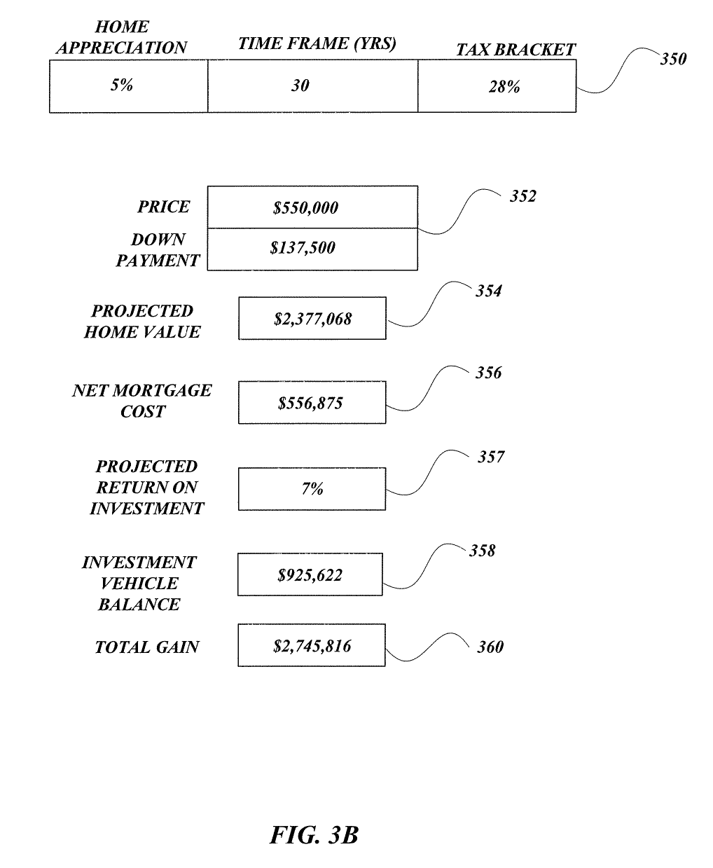

Now with reference to FIGS. 3A-3B, financial statements for two competing loan/investment products will be described. In accordance with one embodiment, the loan modeling program 214 described above with reference to FIG. 2 may be used to produce financial statements similar to the statements depicted in FIGS. 3A-3B. The example depicted in FIG. 3A provides information about a traditional 30-year fixed mortgage. In this instance, the entry 300 indicates that the average home appreciation over the lifetime of the loan is predicted to be 5% with the borrower's marginal tax rate being in the twenty-eight percent (28%) tax bracket. As entry 302 indicates, the purchase price of the home is $550,000 with a $137,500 down payment being provided. Once the loan modeling program 214 performs calculations, the projected value of the home at the end of the loan is provided in entry 304. Similarly, the net mortgage cost is provided in entry 306. In this example, none of the capital in the borrowers' payment is directed into an investment vehicle as indicated by entry 308. By subtracting the net mortgage cost from the summation of the projected value of the home and the balance of the investment vehicle, a total is calculated and provided in entry 310.

The example depicted in FIG. 3B illustrates a financial statement when the loan/investment vehicle is a separate account mortgage provided by the present invention. In this instance, the entry 350 indicates that the average home appreciation over the lifetime of the loan is the same as the example described in FIG. 3A, namely 5% with the borrower's marginal tax rate being in the twenty-eight percent (28%) tax bracket. As entry 352 indicates, the purchase price of the home is $550,000 with a $137,500 down payment being provided. Once the loan modeling program 214 performs calculations, the projected value of the home is identified in entry 354. Similarly, the net mortgage cost is provided in entry 356. Moreover, the projected balance of the capital in the investment vehicle is identified an entry 358 based on the predicted rate of return of seven percent (7%) as indicated in entry 357. By subtracting the net mortgage cost from the summation of the projected value of the home and the balance of the investment vehicle, a total is calculated and provided in entry 360.

In a preferred embodiment of the present invention, capital that would be applied to the principal of a home loan is invested, preferably in an EIUL to minimize investment risk. The results of this method are illustrated in FIGS. 3A-B, with a greater gain in capital being accumulated when the separate account mortgage provided by the present invention is utilized when compared to a traditional 30-year fixed mortgage. As depicted in FIGS. 3A-B, the principal of the separate account mortgage of the present invention does not decrease during the life of the mortgage, thereby resulting in a higher gross mortgage cost when compared to a 30-year fixed mortgage. However, the capital directed to the investment vehicle more than offsets the extra interest costs of the mortgage and a higher tax deduction is maintained with the higher interest cost. Moreover, capital earned by the investment vehicle is reinvested, thereby producing compound gains.

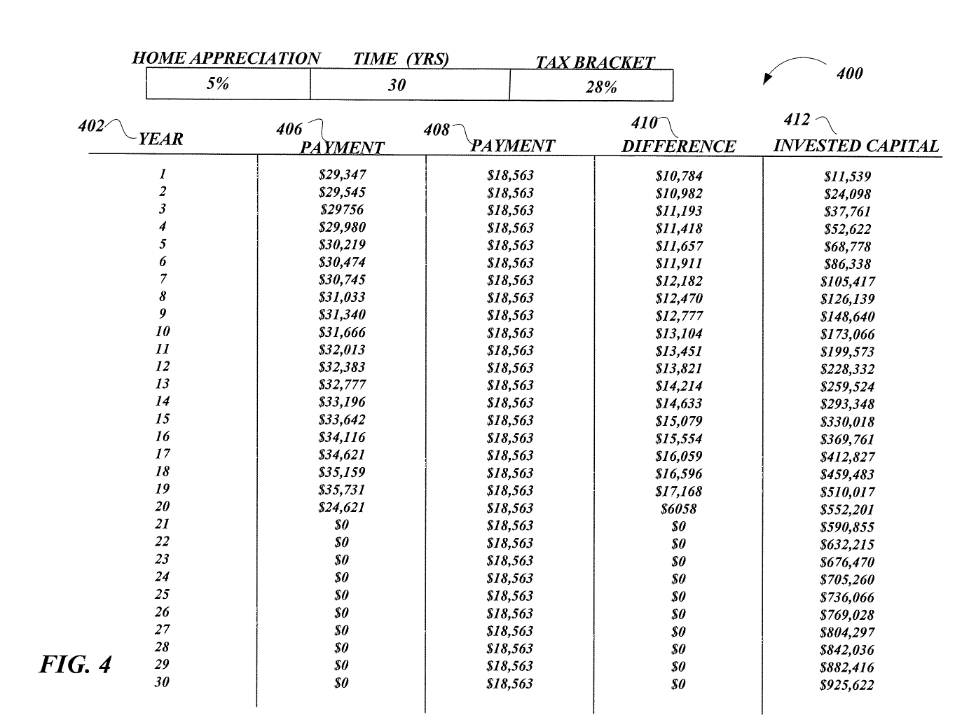

Now with reference to FIG. 4, an amortization schedule 400 that further illustrates additional aspects of the present invention is described. As illustrated in FIG. 4, the amortization schedule 400 includes data in the columns 402, 404, 406, 408, and 410. These columns contain data describing two different types of products; namely a 30-year fixed mortgage and a separate account mortgage that is provided by aspects of the present invention. In this example, the mortgage amount for both loans is $412,500, with an interest-rate of 6.25%, and a borrower's tax rate of 28%. The monthly payment for the 30-year fixed loan is $2,539.83. If a fixed rate interest-only mortgage is used, the monthly payment would typically be $2,148.44. However, in one embodiment, the monthly payment difference between a 30-year fixed mortgage and the fixed rate interest-only mortgage is directed to an investment vehicle. Thus, in this embodiment, the payment for the borrower utilizing the separate account mortgage provided by the present invention is $2,539.83 of which $2,148.44 goes toward the fixed rate interest-only mortgage. As mentioned previously, the remaining capital is directed to an investment vehicle.

FIG. 4 illustrates the affects of using the separate account mortgage provided by the present invention over time when compared to the 30-year fixed mortgage. In this regard, the YEAR COLUMN 402 provides an indicator of the current year in repayment for the mortgages. As further illustrated in FIG. 4, the PAYMENT COLUMN 406 displays the net mortgage amount paid after accounting for the tax deduction in the appropriate year of a 30-year fixed mortgage. Similarly, the PAYMENT COLUMN 408 displays the net mortgage amount paid for the separate account mortgage that is provided by aspects of the present invention after accounting for the tax deduction. Moreover, the DIFFERENCE COLUMN 410 displays the difference between the net payment in the 30-year fixed mortgage and the separate account mortgage for each repayment year. Finally, the INVESTED CAPITAL COLUMN 412 displays the capital that is directed to the investment vehicle provided by the separate account mortgage of the present invention. Stated differently, the value in the INVESTED CAPITAL COLUMN 412 represent the summation of the difference between the net mortgage payment in the 30-year fixed and the separate account mortgage that is earning a rate of return for the borrower.

As illustrated in FIG. 4, the separate account mortgage provided by the present invention allows a borrower to utilize a mortgage that provides a greater tax savings than a traditional fixed rate mortgage. At the same time, capital is allocated for investment that grows tax-deferred and may be excluded from taxable income. By freeing this cash flow, a new source of savings is created as indicated in the INVESTED CAPITAL COLUMN 412 represented in FIG. 4. In one embodiment, this is accomplished with the same payment amount that would be required with a 30-year fixed mortgage.

Utilization of the method of the present invention by commercial lenders, including but not limited to qualified financial institutions, banks, mortgage companies, insurance companies and credit unions, provides an advantageous financial product as stated above with minimal or no risk to the borrower or lender. A mortgage company could lend money for this type of no-risk or low-risk investment product to encourage accumulation of savings by individuals who otherwise may not be in the savings market. The separate account mortgage product could provide a vehicle for lending money by the method of the present invention to buy a lender controlled investment product, setting up repayment by a schedule and paying the gain to the borrower during or at the end of the loan.

While the presently preferred embodiment of the invention has been illustrated and described, it will be readily appreciated by those skilled in the art and others that, within the scope of the appended claims, various changes can be made therein without departing from the spirit and scope of the invention.

The embodiments of the invention in which an exclusive property or privilege is claimed are defined as follows:

1. A method for increasing the capital available to a borrower, the method comprising: establishing an integrated account of a mortgage and an investment vehicle that receives periodic payments from the borrower; bifurcating the payment so that a portion of the payment is directed to the mortgage and the remaining portion is directed to the investment vehicle; providing means for growing capital directed to the investment vehicle at a rate that is greater than the cost of the interest on the mortgage; and wherein the portion directed to the investment vehicle would have otherwise been used to pay down the principal of the mortgage.

2. The method as recited in claim 1, wherein the portion of the payment directed to the mortgage is the cost of interest for the mortgage.

3. The method as recited in claim 1, wherein the investment vehicle is an Equity-Indexed Universal Life Insurance Policy that grows capital tax-deferred.

4. The method as recited in claim 1, providing means for growing capital directed to the investment vehicle at a rate that is greater than the cost of the interest on the mortgage includes directing tax savings produced by utilizing an interest only mortgage to the investment vehicle.

5. A system of integrating a home mortgage with an investment product, comprising: an integrated account that periodically receives a payment from a borrower; a payment means associated with the account for directing a portion of the payment received from the borrower to a mortgage and the remaining portion to an investment vehicle; and wherein the portion of the payment directed to the mortgage is the interest on a home loan and the portion of the payment directed to the investment vehicle provides tax deferred growth.

6. The system as recited in claim 5, wherein the mortgage is a fixed rate interest-only mortgage.

7. The system as recited in claim 5, wherein the investment vehicle is an Equity-Indexed Universal Life Insurance Policy.

8. A loan modeling program for modeling a separate account mortgage by performing a method that identifies the costs of a home loan and the revenues produced from an investment vehicle, the method comprising: accepting model parameters from a user interface that identify the terms of the home loan and attributes of the home; calculating a net mortgage costs, projected value of the home, and a projected balance of the capital in the investment vehicle; and comparing the mortgage costs, projected value of the home, and the projected balance of the investment vehicle for the separate account mortgage with another mortgage product.
